(19) United States
(12) Patent Application Publication
(10) Pub. No.: US 2007/0275248 A1
(43) Pub. Date: Nov. 29, 2007

(54) Film and method for making the same and method for making an IML product

(75) Inventors: Jeng-Chi Peng, Tu-Cheng (TW); Ting-You Wu, Tu-Cheng (TW); Fei Xiao, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,898

(22) Filed: Oct. 24, 2006

(30) Foreign Application Priority Data
May 26, 2006 (CN) 200610060787.6

(51) Int. Cl. B32B 9/04; B05D 1/36; B29C 45/00; B32B 27/36

(52) U.S. Cl. 428/412; 264/238; 427/209; 428/411.1; 428/497

(57) ABSTRACT

A method for making an IML (in-mold labeled) product (40), comprising: providing a substrate (31) having a first surface (311) and an opposite second surface (312); forming a patterned layer (32) on the first surface of the substrate by printing; forming a hard coated layer (33) on the second surface of the substrate by a hard coating method, thereby obtaining a film (30); hot pressing the film by a hot press forming method, and trimming the film to remove excess portions; and with the patterned layer exposed, putting the film into a mold having a cavity, and insert molding the film such that a base (34) joined with the patterned layer is formed, wherein the combined base and film constitute the product. The application also provides the above-described film including a patterned layer and a hard coated layer and a method for making the film.

### FIELD OF THE INVENTION

The present invention generally relates to films used on products such as enclosures of electronic devices, methods for making such films, and methods for making IML (in-mold labeling) products.

### DISCUSSION OF THE RELATED ART

In-mold labeling (IML) is a labeling technique that is used in blow molded, injection molded, and thermoformed containers. Products made by IML generally have good-looking and fadeless surfaces.

Referring to FIG. 1, a film 22 includes a transparent substrate 221 and a patterned layer 222. The substrate 221 has two surfaces 2211 and 2212 at opposite sides thereof. The patterned layer 222 is formed on the surface 2211.

Referring to FIG. 2, a product 20 made by the method of IML includes a base 21, the above-described film 22, and a transparent protecting layer 23. The protecting layer 23 is formed on the surface 2212 to protect the substrate 221. The method of making the product 20 includes the following steps: providing the substrate 221; forming the film 22 by formed the patterned layer 222 on the surface 2211 of the substrate 221; processing the film 22 using a hot press forming method so that the film 22 is shaped the same as the product 20; trimming the film 22 to remove excess portions; putting the film 22 into a mold and then injecting molten material into the mold, whereby the molten material attaches to the film 22 when the molten material is solidified; and finally, applying the protecting layer 23 on the surface 2212, whereby the product 20 is obtained.

However, the product 20 commonly has a complex shape with depressions and protrusions, which makes the step of applying the protecting layer 23 complex and problematic. Typically, some areas are not protected by the protecting layer 23. In addition, a thickness of the protecting layer 23 is often not uniform.

Therefore a film, and a method of making the film, and a method for making an IML product which solve the above-described problems are desired.

### SUMMARY

In one aspect, a film includes a transparent substrate, a patterned layer and a hard coated layer. The transparent substrate includes a first surface and a second surface at two opposite sides thereof. The patterned layer is formed on the first surface of the substrate. The hard coated layer is formed on the second surface of the substrate.

In another aspect, a method for making a film includes: providing a substrate having a first surface and an opposite second surface; forming a patterned layer on the first surface of the substrate by printing; and forming a hard coated layer on the second surface of the substrate by hard coating.

In a further aspect, a method for making an IML (in-mold labeled) product, includes: (1) providing a substrate having a first surface and an opposite second surface; (2) forming a patterned layer on the first surface of the substrate by printing; (3) forming a hard coated layer on the second surface of the substrate by a hard coating method, thereby obtaining a film; (4) hot pressing the film by a hot press forming method, and trimming the film to remove excess portions; and (5) with the patterned layer exposed, putting the film into a mold having a cavity, and insert molding the film such that a base joined with the patterned layer is formed, wherein the combined base and film constitute the product.

Other advantages and novel features will become more apparent from the following detailed description when taken in conjunction with the accompanying drawings.

### BRIEF DESCRIPTION OF THE DRAWINGS

All the drawings are cross-sectional views. The components in the drawings are not necessarily drawn to scale, the emphasis instead being placed upon clearly illustrating the principles of the present film, method of making the film, and method for making an IML product. Moreover, in the drawings, like reference numerals designate corresponding parts throughout the several views.

FIG. 1 is a conventional film used in IML.

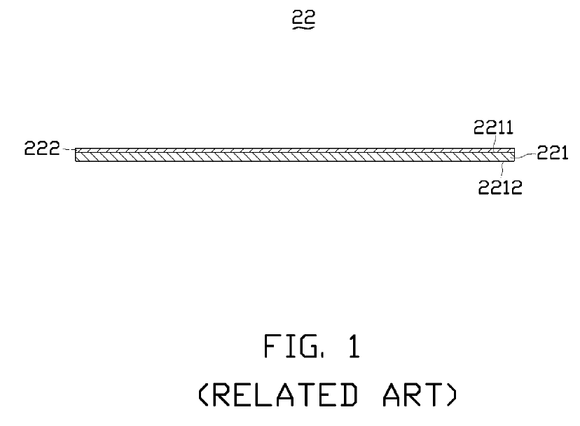

FIG. 2 is a product made by IML and employing the film of FIG. 1.

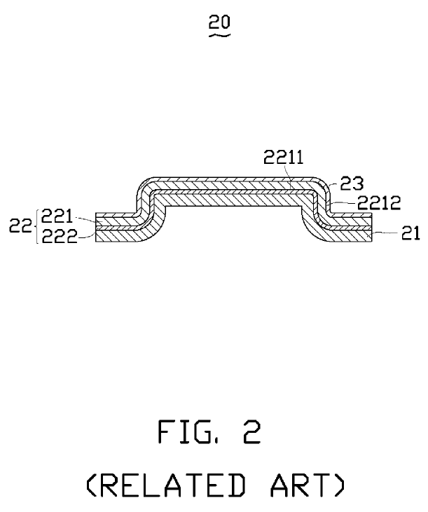

FIG. 3 is a film in accordance with one embodiment of the present invention.

FIG. 4A is a substrate of the film of FIG. 3.

FIG. 4B is the substrate of FIG. 4A coated with a patterned layer.

FIG. 4C is the film of FIG. 3 after it has been hot pressed.

FIG. 4D is an IML product, which includes the film shown in FIG. 4C and a base.

### DETAILED DESCRIPTION OF THE EMBODIMENTS

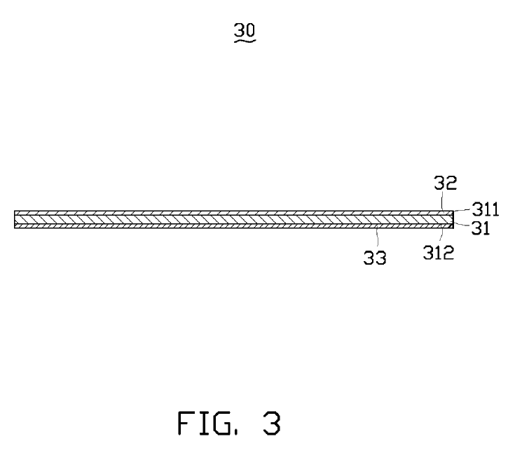

Referring to the drawings in detail, FIG. 3 shows a film 30 of one embodiment of the present invention. The film 30 includes a transparent substrate 31, a patterned layer 32, and a transparent hard coated layer 33. The substrate 31 has a first surface 311 and a second surface 312 at opposite sides thereof. The patterned layer 32 is disposed on the first surface 311, and the hard coated layer 33 is disposed on the second surface 312. The film 30 is used in applications such as enclosures of electronic devices and other commodities.

The substrate 31 is a flat transparent thin film having a thickness of from about 0.127 to about 0.381 millimeters (mm). The substrate 31 is made of polycarbonate. The patterned layer 32 is a printed ink film with desired patterns such as pictures and letters. The patterned layer 32 has a thickness of from about 0.02 to about 0.03 mm. The hard coated layer 33 has a thickness of from about 0.01 to about 0.015 mm. A surface hardness of the hard coated layer 33 is at least 2H or more. That is, for example, if a lead pencil having a hardness of 2H is worked on the hard coated layer 33 with a force of 0.5 g (g stands for acceleration of gravity), no nick can be formed in the hard coated layer 33. The hard coated layer 33 is formed by applying varnish on the second surface 312 of the substrate 31 and then baking the varnish using a baking machine such as an oven. The varnish may be transparent varnish or varnish that turns transparent after baking, so long as the formed hard coated layer 33 is transparent. In a preferred embodiment, the varnish comprises 60˜70% by weight of acrylic resin, 5˜20% by weight of silicon-acrylic, and 20˜25% by weight of thinner.

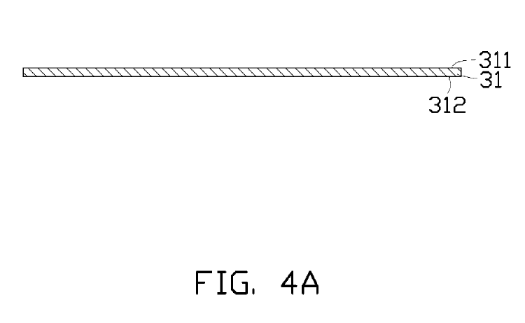

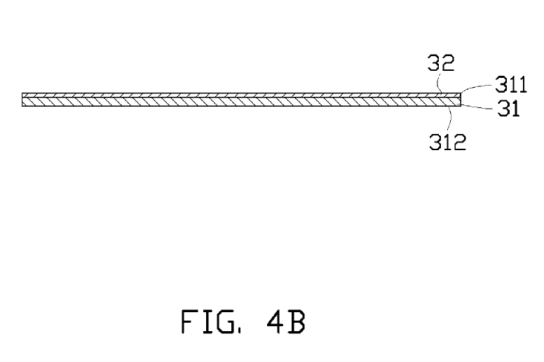

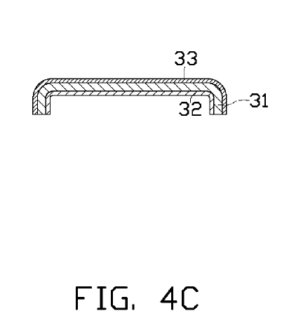

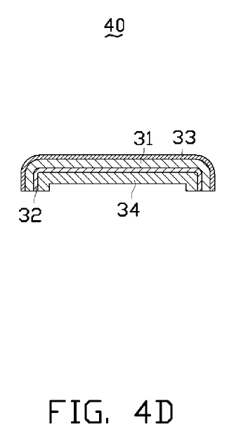

Referring to FIG. 4A and FIG. 4B, an exemplary method for making the film 30 includes the following steps. Firstly, the above-described substrate 31 is provided, as shown in FIG. 4A. Secondly, the patterned layer 32 is formed on predetermined areas of the first surface 311 of the substrate 31 by painting or printing, as seen in FIG. 4B. For example, the patterned layer 32 may be formed by flat film printing. Finally, the hard coated layer 33 is formed on the second surface 312 of the substrate 31 by hard coating, as seen in FIG. 3. The hard coated layer 33 is formed by applying varnish on the second surface 312 of the substrate 31, and then baking the varnish. A temperature for baking is from about 60 to about 80 degrees Celsius, and a baking period is roughly between 10˜30 minutes. The hard coated layer 33 formed has nice malleability.

The present application further provides an exemplary method for making an IML product, which includes the following steps: (1) the film 30 is formed by the above-described method; (2) the film 30 is then trimmed to remove excess portions, and is formed into a predetermined shape by a hot press forming method, as seen in FIG. 4C; and (3) with the patterned layer 32 exposed, the film 30 is processed using a film insert molding method. The film insert molding method typically includes the following steps. The film 30 with the patterned layer 32 is put into a cavity of a mold. Molten material is then injected into the cavity of the mold. After a process of heat preservation and cooling, the molten material is solidified and thereby forms a base 34 on which the film 30 is attached, as seen in FIG. 4D. That is, an IML product 40 is formed. In the IML product 40, the patterned layer 32 is attached to the base 34.

In summary, in the above-described method for making the film 30, the step of hard coating is performed on a flat surface, i.e., the second surface 312 of the substrate 31. Therefore, there is no spray dead angle when the hard coated layer 33 is formed. That is, unlike with the above-described protecting layer 23 of the conventional product 20, the second surface 312 is fully coated by the hard coated layer 33, and a thickness of the hard coated layer 33 is more uniform. In addition, when the above-described method for making an IML product is employed in mass production, since the hard coating process is done before the hot press forming and the film insert molding procedures, any reject films 30 produced during the hard coating process can be promptly discarded. That is, the subsequent steps in the IML method are only performed on good films 30. This in effect lessens the total manufacturing cost. Further, the hard coated layer 33 can enhance the surface hardness and luster of the IML product 40 obtained, whereby chemical reactions, UV (ultraviolet) radiation reactions, and scratches are prevented.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A film, comprising:
a transparent substrate, which comprises a first surface and a second surface at two opposite sides thereof;
a patterned layer formed on the first surface of the substrate; and
a hard coated layer formed on the second surface of the substrate.

2. The film as claimed in claim 1, wherein the hard coated layer comprises baked varnish.

3. The film as claimed in claim 2, wherein the varnish comprises at least 60% by weight of acrylic resin, and at least 5% by weight of silicon-acrylic.

4. The film as claimed in claim 1, wherein the hard coated layer has a thickness of from about 0.01 millimeters to about 0.015 millimeters.

5. The film as claimed in claim 1, wherein the hard coated layer has a surface hardness of 2H or more.

6. The film as claimed in claim 1, wherein the substrate is a flat transparent thin film having a thickness of from about 0.127 millimeters to about 0.381 millimeters.

7. The film as claimed in claim 1, wherein the substrate is made of polycarbonate.

8. The film as claimed in claim 1, wherein the patterned layer is a printed ink film.

9. The film as claimed in claim 1, wherein the patterned layer has a thickness of from about 0.02 millimeters to about 0.03 millimeters.

10. A method for making a film, comprising:
providing a substrate having a first surface and an opposite second surface;
forming a patterned layer on the first surface of the substrate by printing; and
forming a hard coated layer on the second surface of the substrate by hard coating.

11. The method as claimed in claim 10, wherein the hard coated layer is formed by painting varnish on the second surface and baking the varnish.

12. The method as claimed in claim 11, wherein a baking temperature is in the range from 60 to 80 degrees Celsius, and a baking period is in a range from 10 to 30 minutes.

13. A method for making an IML (in-mold labeled) product, comprising:
(1) providing a substrate having a first surface and an opposite second surface;
(2) forming a patterned layer on the first surface of the substrate by printing;
(3) forming a hard coated layer on the second surface of the substrate by a hard coating method, thereby obtaining a film;
(4) hot pressing the film by a hot press forming method, and trimming the film to remove excess portions; and
(5) with the patterned layer exposed, putting the film into a mold having a cavity, and insert molding the film such that a base joined with the patterned layer is formed, wherein the combined base and film constitute the product.

14. The method as claimed in claim 13, wherein in the insert molding, molten material is injected into the cavity of the mold, the molten material is heat preserved and cooled, and the molten material then solidifies to form the base.

15. The method as claimed in claim 13, wherein in the forming of the hard coated layer, varnish is on the second surface of the substrate and then baked, wherein the painted varnish comprises 60˜70% by weight of acrylic resin, 5˜20% by weight of silicon-acrylic, and 20˜25% by weight of thinner.

16. The method as claimed in claim 13, wherein a baking temperature is in the range from 60 to 80 degrees Celsius, and a baking period is in a range from 10 to 30 minutes.

17. The method as claimed in claim 13, wherein the substrate is a flat transparent thin film having a thickness of from about 0.127 millimeters to about 0.381 millimeters, the patterned layer has a thickness of from about 0.02 millimeters to about 0.03 millimeters, and the hard coated layer has a thickness of from about 0.01 millimeters to about 0.015 millimeters.

18. The method as claimed in claim 13, wherein the substrate is made of polycarbonate.

19. The method as claimed in claim 13, wherein the patterned layer is a printed ink film.
